(19) United States
(12) Patent Application Publication
(10) Pub. No.: US 2015/0321609 A1
(43) Pub. Date: Nov. 12, 2015

(54) BEARING ARRANGEMENT FOR ROTATABLE BEARING OF AN INDIRECT SIGHT SYSTEM, AS WELL AS THE INDIRECT SIGHT SYSTEM HEREWITH

(71) Applicant: Mekra Lang GmbH & Co. KG, Ergersheim (DE)

(72) Inventors: Werner Lang, Ergersheim (DE); Sebastian Heger, Markt Nordheim (DE)

(21) Appl. No.: 14/706,180

(22) Filed: May 7, 2015

(30) Foreign Application Priority Data
May 8, 2014 (DE) 10 2014 208 688.4

(51) Int. Cl. B60R 1/06; F16C 25/08; F16C 19/54

(52) U.S. Cl. CPC B60R 1/06; F16C 19/54; F16C 25/083

(57) ABSTRACT

Described is an bearing arrangement (2) for rotatable bearing of at least one indirect sight system, for example in the form of a rear-view mirror (4), in particular an external rear-view mirror, to a motor vehicle, especially a utility vehicle, with a first bearing part (8) and a second bearing part (10), which are connected to one another rotationally on a rotational axis (A). The first bearing part (8) is a support or mirror arm (12) with at least one area of join (14) e.g. arranged for the rear-view mirror (4) and in the form of a cylinder (16), which with regard to the rotational axis (A) has rotation-symmetrical lateral surfaces (18). The second bearing part (10) can be fixed to a bodywork part (6) of the motor vehicle and has at least one bearing surface encompassed by the lateral surface (18) of the first bearing part (8) at least in sections. The first bearing part (8) is formed from a metal spigot encased in plastic (38), which is connected with the mirror arm (12) in a torque-proof way.

### FOREIGN PRIORITY STATEMENT

The present application claims priority under 35 D.S.C. §119 to German Patent Application No. 10 2014 208 688.4, filed on May 8, 2014, and which is incorporated by reference in its entirety herein.

### FIELD OF THE INVENTION

The invention concerns a bearing arrangement for rotatable bearing of an indirect sight system, for example in the form of at least one rear-view mirror, in particular an external rear-view mirror on a motor vehicle, as well as an indirect sight system with at least one such bearing arrangement.

### BACKGROUND OF THE INVENTION

It is generally known to fix indirect sight systems, so especially, but not exclusively, exterior rear-view mirrors to a motor vehicle, in particular a utility vehicle, in a rotatable way in order to be able to rotate the (indirect) sight system when needed from a use or operating position in a folded position, in which the indirect sight system comes to lie at least approximately parallel along the vehicle bodywork. Such a swing of the sight system is carried out either deliberately or intentionally, for example in order to reduce the vehicle's width or it is carried out quasi-independently or automatically if the sight system strikes an obstacle.

For the rotatable bearing of e.g. external rear-view mirrors on motor vehicles or respectively vehicle bodies, the state of the art suggests a multitude of constructions which sometimes differ from one another significantly. A generally known approach to construction is to form the actual rear-view mirror or mirror arm or general support arm carrying the mirror head in the form of a pipe which is held in a corresponding retaining sleeve or retaining case of the vehicle and is rotatable herein. An example of such a construction is in U.S. Pat. No. 5,025,543 A1.

bearing part is arranged on a support arm with at least one connecting area for the indirect sight system; and the second bearing part can be fitted to the vehicle and at least in sections encompasses the first bearing part. The first bearing part is made up of a plastic-coated metal spigot which is connected to the support arm in a torque-proof manner.

Because the first bearing part is made of a metal spigot, the bearing arrangement according to the invention has the necessary mechanical stability in order to also be able to bear heavy and/or far protruding indirect sight systems, such as rear-view mirrors in a way which is safe, long-life and with the least possible vibrations. Through the torque-proof support arm there is a direct flow of force or a direct introduction of force from the support arm in the stable metal spigots. The further feature that the metal spigot forming the first bearing part is coated in plastic, has the result that half-finished products of lower grade can be used for the production of the metal spigot. Possible incertitude on the surface, irregularities on the surface in the form of tool traces or the like will be leveled out or smoothed through the plastic coating, so that a bearing part with correct dimensions, correct surface grade and good fit is maintainable. If half-finished products of a higher grade are used to produce the metal spigot, on which there are no surface irregularities caused by production of the half-finished product, traces of processing from post-processing the half-finished product in the course of producing the support arm (tool traces or the like) can also be covered, leveled out and smoothed by the plastic coating.

In conclusion, the design of the first bearing part as plastic-coated metal spigot which is connected to the support arm in a torque-proof way, produces a bearing arrangement which is stable, long-life, satisfies all requirements arising in practice and is inexpensive to produce.

According to a preferred design, the first bearing part is designed in the form of a cylinder, which has a rotation-symmetrical lateral surface relative to the rotational axis, whereby the second bearing part encompasses the lateral surface of the first bearing part, at least in sections. This represents a design which is low in costs in terms of production technology and also a permissible and long-life design in practice. Within the framework of the present invention, constructions differing to this, in particular the first bearing part, are possible, which then require corresponding designs of the second bearing part. Instead of the cylinder shape with rotation-symmetrical lateral surface, the first bearing part can also have a cone or frustum shape. Furthermore, at least one strip or projection can extend from the lateral surface of the first bearing part which runs along the lateral surface so that there is a line contact between the first and second bearing part along the projection.

According to another preferred design, the metal spigot is hollow, i.e. designed as a metal pipe. This is beneficial with a view to the costs, material savings, weight savings, easier ductility, in particular bendability and the possibility to lay cables or other lines for additional functions of the indirect sight system (power cables and signal cables for e.g. cameras or light emitters, mirror heating, indicator lights in the mirror head, motor camera or mirror adjustment etc.) on the inside of the metal pipe.

According to one design the metal pipe can be a pipe end which extends axially beyond the bearing arrangement into a section of the support arm neighbouring one of the two bearing parts. The metal pipe of the first bearing part therefore essentially only runs in the section particularly stressed, where the first bearing part and the second bearing part are led into one another. This results in a weight saving of the entire rearview mirror application, since the metal pipe does not extend unnecessarily far in the support arm, but rather only axially beyond the bearing arrangement in a section of the support arm neighbouring there in order to provide sufficient axial length so that the torque-proof connection with the support arm can be produced.

In another form of design the metal pipe can be a pipe which extends beyond the bearing arrangement essentially along the entire length of the support arm. This design is therefore particularly preferable if especially high forces are to be expected on the support arm, so the support arm should be strengthened through the pipe running through it. One part of the length section of the pipe therefore forms the first bearing part which is taken in the second bearing part and remaining section of the pipe runs essentially across the entire length of the support arm. The torque-proof connection with the support arm is therefore achieved by means of the one-piece design of the pipe.

The material for the plastic coating of the metal spigot can preferably be the same material as the support arm, if this support arm is made of a plastic, for visual, aesthetic or production-technical reasons. This design form produces the particular advantage, if the plastic coating material is a thermoplastic, that the metal spigot can be coated in the material of the support arm during its production moulding with the material there and coated along at least a part of its lateral surface with the same material. Therefore, in one stage of production the metal spigot or respectively the metal pipe can be connected with the support arm in a torque-proof way or respectively embedded essentially along the entire length of this and the plastic coating of the metal spigot can be formed to form the first bearing part. Instead of a thermoplastic, other plastics or materials generally can also be used, which then, where applicable, require a different production process when coating the spigot or respectively embedding the support arm or support arm section, since they are not accessible in a thermoplastic processing stage, so e.g. glass or carbon fibre reinforced plastics.

Preferably the second bearing part encompasses the spigots of the first bearing part at two bearing positions spaced axially from one another, whereby one bearing position lies in the area of the exit of the spigot from the bearing arrangement, and the other bearing position lies in the area of the end section of the spigot applied to the support arm. In this way the spigot of the first bearing part undergoes a bearing or hold at two positions spaced a maximum distance from one another structurally and therefore a particularly good support is achieved.

Moreover this offers the possibility to arrange a spring device between the two bearing positions, which pre-tensions the spigots axially in one direction in the bearing arrangement. This spring device which pre-tensions the spigots in the bearing arrangement produces a better resistance to vibrations of the entire bearing arrangement. Moreover, this axial pre-tensioning of the spigot can preferably be brought to at least one catch and/or friction mechanism for the pivot movement between the two bearing parts.

The indirect sight system is at least one rear-view mirror, in particular external rear-view mirror, in one design of the present invention. By “at least one” it should be understood that the indirect sight system can also be understood as a mirror head which bears two or more individual mirrors.

The object of the current invention is furthermore an external rear-view mirror, in particular (but not exclusively) in the form of an external rear-view mirror for a motor vehicle, especially a utility vehicle with at least one bearing arrangement according to the invention.

Further particulars, aspects and benefits of the current invention can be explained better in the following description of embodiments or respectively modifications using the drawing.

### BRIEF DESCRIPTION OF THE DRAWINGS

In the figures is:

FIG. 1 a simplified sectional representation through an embodiment of an bearing arrangement according to the invention;

FIG. 2 a representation according to FIG. 1 of a modification to the bearing arrangement of FIG. 1;

FIGS. 3 and 4 sectional views of bearing arrangements with an bearing arrangement according to FIG. 1, as well as modifications to support arms arranged on it;

FIG. 5 a view of an bearing arrangement in duplicate; and

FIG. 6 a view of the bearing arrangement from FIG. 3 with an indirect sight system in the form of a rear-view mirror arranged on it.

### DETAILED DESCRIPTION OF THE INVENTION

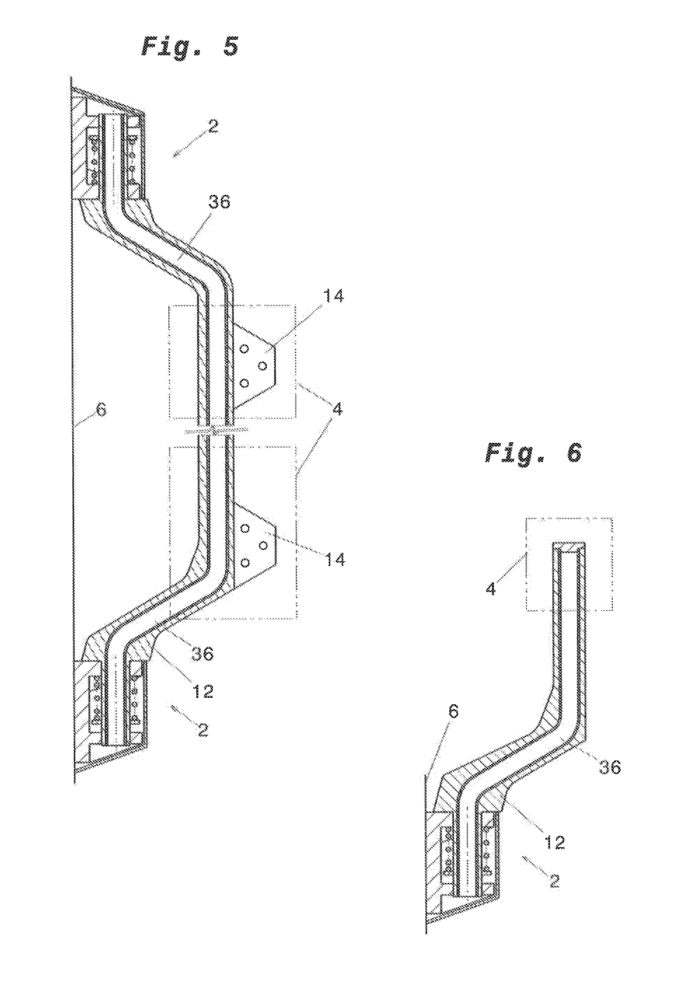

An bearing arrangement according to the present invention denoted with 2 in the Figures serves the purpose of a pivoting bearing of a rear-view mirror 4 (FIGS. 5 and 6) described as an “indirect sight system”, especially an external rear-view mirror, on a motor vehicle, or respectively to a bodywork part 6 of this motor vehicle. The “indirect sight system” can also have another technical permutation, e.g. in the form of a camera or the like. The following description focuses on the design of the indirect sight system as a rear-view mirror. Other designs are to be considered as equivalent.

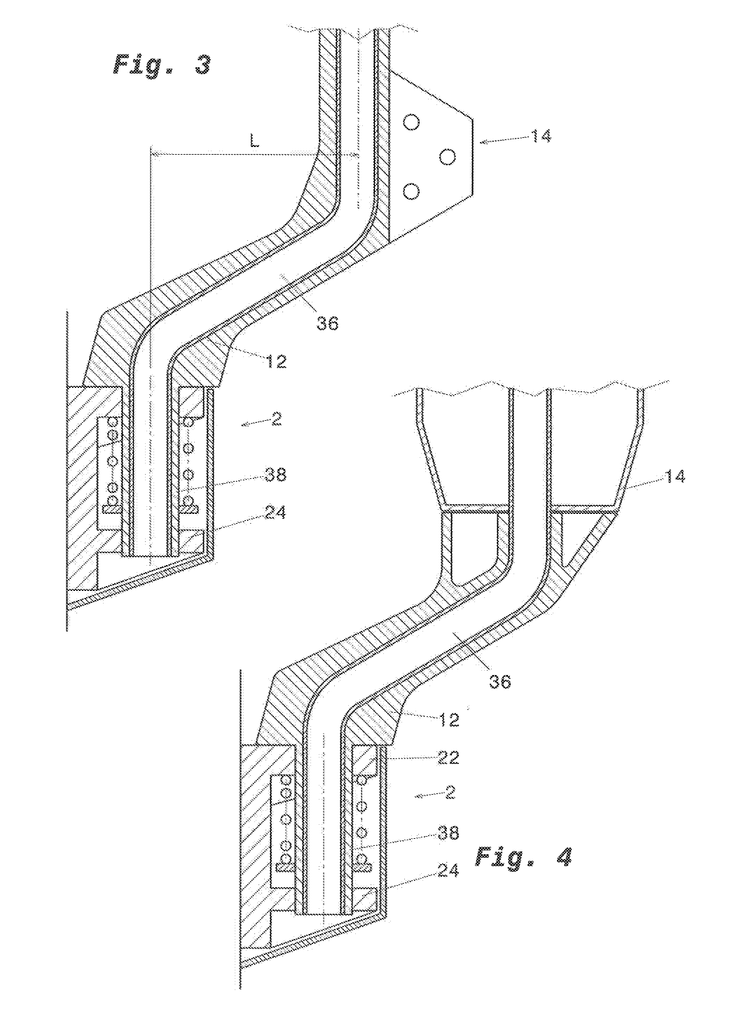

The bearing arrangements 2 includes essentially a first bearing part 8 and a second bearing part 10, which are connected to one another in a swivelling way with a rotational or pivot axis A. The first bearing part 8 is arranged as a mirror arm 12 described generally as a support arm, whereby the mirror arm 12 as shown in FIGS. 3 and 5 have at least one area of the join 14 for at least one rear-view mirror 4. The first bearing part 8 is designed in the embodiment represented as an exact circular cylinder 18, which has rotation-symmetrical lateral surface 18 relative to the axis A. As already explained, the first bearing part 8 and/or its lateral surface 18 can also have a geometric form and/or surface design differing from this.

In the Figures of the drawing, the bearing arrangement 2 or respectively its second bearing part 10 is arranged directly on the vehicle or respectively the bodywork part 6 of the vehicle. This arrangement can however also be indirect, i.e. interposing one or more other construction parts or elements, e.g. a bracket, console etc.

The second bearing part 10 can be fitted using a foot 20 on the bodywork part 6 and has at least one bearing surface, at least in sections encompassing the lateral surface of the first bearing part 8.

In the following, more details will be provided about the design and arrangement of the bearing surfaces mentioned.

The second bearing part 10 can show the construction represented in the drawing, i.e. it shows two flanges 22 and 24 distanced from each other axially along the direction of Axis A, from the foot 20 standing out from the bodywork part 6. In the area of the upper, first flange 22 in FIG. 1, there is a first bearing position 26 for the first bearing part 8 and in the area of the lower, second flange 24 in FIG. 1 there is a second bearing position 28 for the first bearing part 8. The first and second bearing positions 26 and 28 can be aligned with bores of the same diameter in the two flanges 22 and 24 in the embodiment represented, in which the first bearing part is designed as an exact circular cylinder. A geometric form of the first bearing part and/or design of the lateral surface 18 can be different from this, possibly with another form and/or another scale and/or another relative arrangement of the two bearing positions 26 and 28 to one another.

The bearing positions (or bores) 26 and 28 according to the Figures of the drawing take in the second bearing part 10. A lower free end of the cylinder 16 of the first bearing part 8 comes to lie in the area of the second bearing position 28 and an end section of the cylinder 16 opposite this lower free end rises above the first bearing position 26, axially above the second bearing part 10 and extends at least partly in the lower end of the mirror arm 12 there, and is connected with this in a torque-proof way.

A spring element is arranged between the two flanges 22 and 24, more accurately between the lower side of the upper flange 22 and a support ring 30, which is a compression spring 32 in the example of design represented. The support ring 30 is fitted on the outer circumference of the cylinder 16, so that through the spring 32 the cylinder 16 and therefore the first bearing part 8 is pre-tensioned downwards in the second bearing part 10 or respectively bearing arrangement 2 in all Figures of the drawing. By means of this pre-tensioning through the spring 32, a lower free surface 34 of the mirror arm 12 is under pressure on the upper site of the upper flange 22 depending on the force of the spring 32. In the area of the interface between the surface 34 on the side of the mirror arm 12 and the upper side of the upper flange 22, catch and/or friction devices can be provided which make it possible to rotate the mirror arm 12 relative to the mirror foot 20 for example in increments or stages, or which keep the mirror arm 12 in a particular position, which can only be raised by exerting a certain force on the mirror arm 12 or which permits an adjustable stiff rotational or pivoting movement of the mirror arm 12.

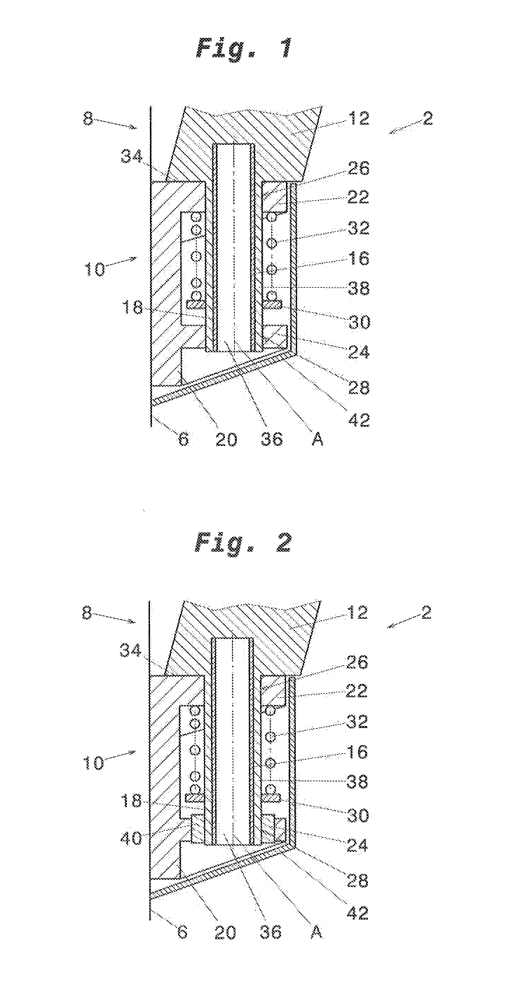

The cylinder 16 of the first bearing part 8 is preferably in the form of a circular cylindrical pipe 36, whereby in the embodiments in FIGS. 1 and 2 the pipe 36 is designed as a pipe stub. In FIG. 1, the upper end of the pipe stub 36 is anchored torque-proof in the lower end section of the mirror arm 12 there, and coming from this the pipe stub 36 extends up to the second bearing position 28, or respectively the bore forming the bearing position 28 in the lower flange 24 of the second bearing part 10 and—as shown in the drawing—where applicable also beyond the bearing position 28 (more or less far or also only slightly).

The pipe or the pipe stub 36 especially is made from suitable metal,

The outer lateral surface 18 of the pipe or pipe stub 36 is provided with a coating 38. This coating 38 is preferably produced from a suitable plastic, in particular a plastic which is thermoplastic and ductile, has sufficient resistance to any loads or influences arising in practice and is in the position to ensure the cylinder 16 is held cleanly in the bores of both bearing positions 26 and 28. The coating 38 or respectively the cylinder 16 with the coating 38 can be understood as a kind of fitting dome which is inserted, pushed in or pressed in to both axially aligned bores or storage of the bearing positions 26 and 28.

Moreover, the plastic coating 38 on the lateral surface 18 of the cylinder 16 or respectively the pipe 36 fulfils the function of levelling out, smoothing or coating surface irregularities and/or tool traces on the lateral surface 18 and/or other incertitude or damages which interferes with or compromises a clean operation of the cylinder 16 in the bearing positions 26 and 28. In other words, in order to produce the cylinder 16 or respectively the pipe or the pipe stub 36 both a half-finished product with a lower grade can be used with practically no consideration of possible tool trace or the like which would distort or damage the lateral surface 18, since such distortions or damages will be smoothed out or leveled out by the coating 38.

Furthermore, the coating 38 represents a protection from erosion for the metal of the cylinder 16 or respectively the pipe stub 36.

The coating 38 can be applied in one production stage on the lateral surface 18 of the cylinder 16, after which the cylinder 16 will be anchored or fixed in a torque-proof way to the lower end of the mirror arm 12.

In the example of execution which is represented in the Figures of the drawing, the coating 38 is made of material of the mirror arm 12 and is one piece with it, i.e. the cylinder 16 will be coated in the course of forming the mirror arm 12 at the same time, for example with a shape spray process and also direction from the material of the mirror arm 12. The mirror arm 12 can therefore be formed in one work stage with the pipe 36 fixed or embedded onto it, the cylinder 16 is moreover fixed with greater reliability opposite the mirror arm 12 in a torque-proof way through the one-piece design of coating 38 and the remaining material of the mirror arm 12, which is then especially important if the cylinder 16 is simply in the form of the pipe stub as shown in FIGS. 1 and 2.

The upper free end of the pipe stub, which lies in the material of the mirror arm 12 can however also show means to prevent rotation, with which a better connection of the material of the mirror arm 12 with the upper surface of the pipe stub is achieved, e.g. knurl or the like.

In the modification according to FIG. 2 in the area of the second bearing position 28 or respectively the lower flange 24 there is an assembly ring 40 which makes assembly of the bearing arrangement simpler.

FIGS. 3 and 4 show a modification of the form of FIG. 1 in which the cylinder 16 is not designed as a pipe stub, but rather the pipe 36 extends from the bearing arrangement 2 essentially along the entire length of the mirror arm 12 to at least to the area where there is at least one connection area 14, in each case depending on the number and the design of the particular rear-view mirror 4 or respectively indirect sight system.

Also in the case of the designs of FIGS. 3 and 4 the coating 38 can either be formed separately on the section of the pipe 36 on the bearing arrangement 2 or respectively the lateral surface 18 there, or the coating 38 is arranged on the lateral surface 18 in one stroke with the design of the mirror arm 12.

The modification according to FIG. 2 with the assembly ring 40 can of course also be used in FIG. 3 or 4.

FIG. 5 shows the possibility to arrange two of the bearing arrangements 2 according to the invention to the bodywork part 6, whereby the two bearing arrangements 2 in each case take in and bear an end section of a pipe 36 which can pivot. The pipe 36 shows in FIGS. 3 to 6 an illustrated example of an elbow or bending and carries one or more rear-view mirrors 4 or respectively indirect sight systems to one section between the two bearing arrangements 2 to corresponding connection areas 14.

FIG. 6 shows how pipe 36 can essentially run along the entire length of the mirror arm 12.

The material for the coating 38 of the spigot is preferably the same material as the mirror or support arm 12. Especially if the coating material is a thermoplastic there is the advantage that the metal spigot is cast en bloc in the course of the production of the mirror arm 12 in the material there and coated along at least a part of its lateral surface with the same material. Therefore, in one work stage the metal spigot or respectively the metal pipe can be connected in a torque-proof way with the mirror arm 12 or respectively be embedded along the entire length of it, and the plastic coating of the metal spigot can be formed to design the first bearing part 8. Instead of a thermoplastic, other plastics or tools can also be used which then require, where applicable, a modified production process to coat the spigot, or respectively embed the mirror arm 12 or mirror arm section, since they are not accessible for a thermoplastic processing stage, so e.g. glass or carbon fibre plastics.

The embodiment form of FIG. 5 with two bearing arrangements 2 can use the design of the bearing arrangement 2 according to FIG. 1. Alternatively or in addition, the assembly ring 40 according to FIG. 2 can be used for the form in FIG. 5,

In all forms of embodiment it is preferable to also have a cover 42 which the bearing arrangement 2 or respectively the area of the second bearing part 10 encompasses. The cover 42 serves to protect from weather conditions (reduce or avoid wind noises) and improve the appearance.

### REFERENCE MARK LIST

2 bearing arrangement
4 rear-view mirror
6 bodywork part
8 first bearing part
10 second bearing part
12 support or mirror arm
14 application area
16 cylinder
18 lateral surface
20 foot
22 flange (upper)
24 flange (lower)
26 first bearing position/bore
28 second bearing position/bore
30 support
32 spring
34 surface
36 pipe
38 coating
40 assembly ring
42 cover
A rotational axis

What is claimed is:

1. Bearing arrangement for rotatable bearing of at least one indirect sight system on a motor vehicle, in particular a utility vehicle, with a first bearing part and a second bearing part, which are connected to one another through a rotational axis, whereby
the first bearing part is arranged on a support arm with at least one area of join for the indirect sight system; and
the second bearing part is fixable to the motor vehicle and encompasses the first bearing part at least in sections;
characterised in that
the first bearing part is made up of a metal spigot encompassed by plastic, which is connected to the support arm in a torque-proof way.

2. Bearing arrangement according to claim 1, characterised in that the first bearing part is in the form of a cylinder and has a rotation-symmetrical lateral surface in relation to the rotational axis, whereby the second bearing part at least in sections encompasses the lateral surface of the first bearing part.

3. Bearing arrangement according to claim 1, characterised in that the metal spigot is formed as a metal pipe.

4. Bearing arrangement according to claim 1, characterised in that the metal pipe is a pipe stub which extends axially beyond the bearing arrangement into a section of the support arm directly neighbouring an bearing arrangement.

5. Bearing arrangement according to claim 1, characterised in that the metal pipe is a pipe which extends beyond the bearing arrangement essentially across the entire length of the support arm.

6. Bearing arrangement according to claim 1, characterised in that the material of the plastic coating of the metal pipe is the same material as the support arm.

7. Bearing arrangement according to claim 6, characterised in that the material of the plastic coating is a thermoplastic.

8. Bearing arrangement according to claim 7, characterised in that the metal pipe, in the course of the production of the support arm, can be coated in the material there which is pourable and coatable along at least one part area of its coat surface with the same material, so that the plastic coating and the support arm are made as one part.

9. Bearing arrangement according to claim 1, characterised in that the second bearing part encompasses the spigots of the first bearing part at two bearing positions spaced axially from one another, whereby the one bearing position lies in the area of the outlet of the spigot from the bearing arrangement in the support arm and the other bearing position lies in the area of the end section of the spigot turned away from the support arm.

10. Bearing arrangement according to claim 9, characterised in that in the area between the two bearing positions a spring system is arranged which pre-tensions the spigots axially in one direction in the bearing arrangement.

11. Bearing arrangement according to claim 10, characterised in that the axial pre-tensioning of the spigot in the bearing arrangement effects at least one catch and/or friction mechanism for the rotational movement between the first and second bearing part.

12. Bearing arrangement according to one of the claim 1, characterised in that the indirect sight system is a rear-view mirror, in particular an external rear-view mirror.

13. Indirect sight system, in particular in the form of at least one external rear-view mirror for a motor vehicle, in particular a utility vehicle, with at least one bearing arrangement according to claim 1.
